(19) United States
(12) Patent Application Publication
(10) Pub. No.: US 2013/0238627 A1
(43) Pub. Date: Sep. 12, 2013

(54) INTEGRATING SEARCHES

(71) Applicants: RICHARD QIAN, REDMOND, WA (US); ANDREW SHUMAN, SEATTLE, WA (US); DERRICK CONNELL, BELLEVUE, WA (US); ROBERT FIRBY, SAN MATEO, CA (US); STEVEN MACBETH, REDMOND, WA (US); TAROON MANDHANA, REDMOND, WA (US)

(72) Inventors: RICHARD QIAN, REDMOND, WA (US); ANDREW SHUMAN, SEATTLE, WA (US); DERRICK CONNELL, BELLEVUE, WA (US); ROBERT FIRBY, SAN MATEO, CA (US); STEVEN MACBETH, REDMOND, WA (US); TAROON MANDHANA, REDMOND, WA (US)

(73) Assignee: MICROSOFT CORPORATION, REDMOND, WA (US)

(21) Appl. No.: 13/413,203

(22) Filed: Mar. 6, 2012

(51) Int. Cl. G06F 17/30

(52) U.S. Cl. 707/741; 707/E17.002; 707/E17.014

(57) ABSTRACT

Methods, systems, and computer-storage media having computer-usable instructions embodied thereon, for integrating searches are provided. An entity index may be compiled that includes entity files for a plurality of identified entities such that any information known about a single entity is contained in a single entity file and is easily accessible. Web indexes, including web page information, may be referenced in order to associate web pages with entities, or entity files. Once identified as related to an entity, a web page may be associated with an entity identifier that is associated with the related entity such that a search query for the identified entity results in both entity information for the entity and web pages associated with the entity.

### BACKGROUND

Conventional search engines provide users with access to vast amounts of information. In order to find desired content, users often input search queries into the search engines and, as a result, are presented with web pages that are determined to be of interest to the user. Typically, the determination to present a web page is based on a keyword-match analysis. Put simply, keywords in the search query are matched to keywords in a web page and web pages having a higher keyword match are presented to a user in a search engine results page (SERP).

This is oftentimes not helpful to a user. For example, in situations where a web page is not the intended desired content of a user, a SERP including the most relevant web pages is not helpful and requires a user to filter through the web pages in order to locate the desired content, if present at all. Sometimes a user is searching for information about entities within or described within a search query rather than web pages. While some user queries are best answered with a stream of web page results, others are best answered by a stream of entity results, and many by a mixture of the two. Thus, entity information should be retrieved for all user queries so that an appropriate mix of entity and web results is displayed to a user.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, methods, and computer storage media for, among other things, integrating searches. Search integration, as used herein, refers generally to providing, in a search engine results page (SERP), entity information to users. The entity information may be presented in combination with one or more web pages, in place of one or more web pages, a combination thereof, or the like. The entity information may be received from an entity index. A web index, including a plurality of web pages, may be referenced to identify web pages that are already associated with a particular entity or that may be associated with the particular entity. The entity information and the web pages may be presented to a user.

In additional embodiments, information that may be related to a particular entity may be associated with an entity identifier previously associated with the particular entity. Additionally, information determined to be associated with the particular entity may be ranked prior to presentation to a user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram that illustrates an environment for integrating searches, in accordance with an embodiment of the present invention;

FIG. 3 is an exemplary graphical user interface illustrating an exemplary display of a single entity search interface, in accordance with an embodiment of the present invention;

FIG. 4 is an exemplary graphical user interface illustrating an exemplary display of an entity category search interface, in accordance with an embodiment of the present invention;

FIG. 5 is a flow diagram showing a method for integrating searches, in accordance with an embodiment of the present invention; and

FIG. 6 is a flow diagram showing a method for integrating searches, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to systems, methods, and computer storage media for, among other things, integrating searches. Search integration, as used herein, refers generally to providing, in a search engine results page (SERP), entity information to users in combination with web results. The entity information may be presented in combination with one or more web pages, in place of one or more web pages, or a combination thereof. The entity information may be received from an entity index, a web index, or a combination thereof. Thus, entity information may be received from the entity index, entities may be associated with web pages and identified in the web index, or both the entity index and the web index may be queried to identify relevant entity information from both indexes. A web index, including a plurality of web pages, may be referenced to identify web pages that may be associated with a particular entity. The entity information and the web pages may be presented to a user.

Accordingly, one embodiment of the present invention is directed to one or more computer storage media storing computer-useable instructions that, when used by one or more computing devices, cause the computing device to perform a method for integrating searches. The method comprises creating an entity index by compiling information received regarding one or more entities. A web index may then be referenced to identify web pages that may be related to the one or more entities. One or more web pages, from the web index, may be identified as related to at least one of the one or more entities. The one or more web pages that are determined to be related to at least one of the one or more entities may then be associated with the at least one of the one or more entities.

Another embodiment of the present invention is directed to a system comprising a processor and a memory for integrating searches. The system comprises a computing device associated with one or more processors and one or more computer-readable storage media, a data store coupled with the computing device, and an integrating engine that creates an entity index by compiling information received regarding one or more entities; references a web index including a plurality of web pages; identifies one or more web pages related to at least one of the one or more entities; and associates the one or more web pages with the at least one of the one or more entities.

Yet another embodiment of the present invention is directed to one or more computer storage media storing computer-useable instructions that, when used by one or more computing devices, cause the computing device to perform a method for integrating searches. The method comprises creating an entity index by compiling information received regarding one or more entities; analyzing the information received regarding the one or more entities to identify an entity description for at least one entity within the information received; mapping the information received regarding the one or more entities to a common ontology; merging each item of information including the entity description for the at least one entity into an entity file; and assigning an entity identifier to the entity file. The web index may then be referenced to identify at least one web page including the entity description for the at least one entity. The at least one web page is then associated with the entity identifier and, upon receiving a search query including the at least one entity, information from the entity file associated with the at least one entity identified within the search query is presented.

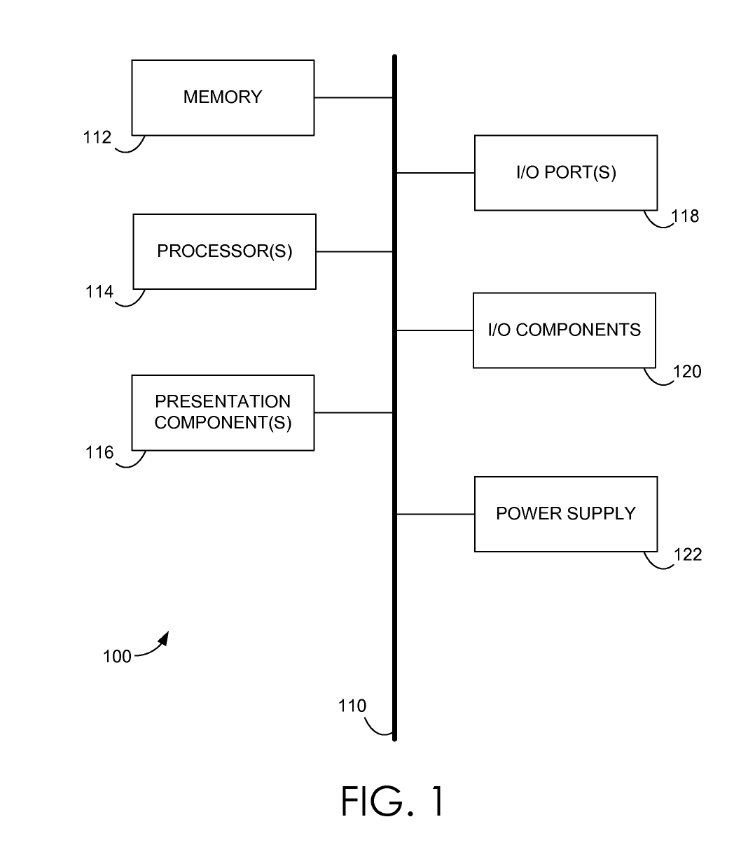

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

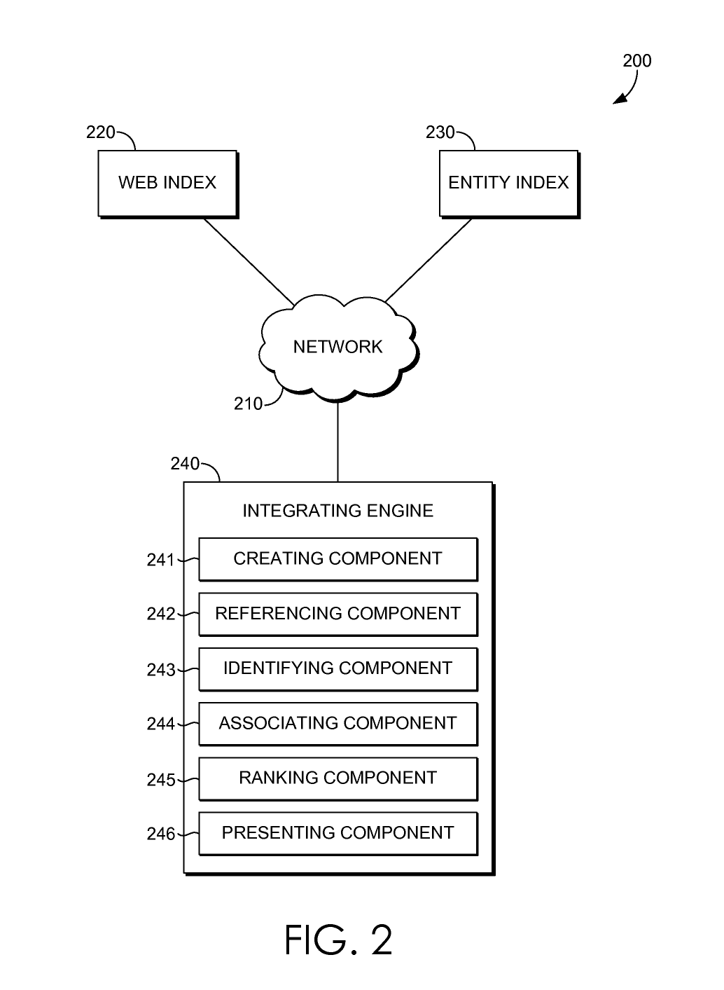

As indicated previously, embodiments of the present invention are directed to integrating searches. Turning now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a network 210, a web index 220, an entity index 230, and an integrating engine 240. The integrating engine 240 may take the form of a dedicated device for performing the functions described below and may be integrated into, e.g., a network access device, a search engine, a server, or the like, or any combination thereof. The components of the computing system 200 may communicate with each other via the network 210, which may include, without limitation, one or more local area networks (LANs) and/or wide area networks (WANs). Such networking environments are commonplace in offices, enterprise-wide computer networks, intranets and the Internet. It should be understood that any number of computing devices and integrating engines may be employed in the computing system 200 within the scope of embodiments of the present invention. Each may comprise a single device/interface or multiple devices/interfaces cooperating in a distributed environment. For instance, the integrating engine 240 may comprise multiple devices and/or modules arranged in a distributed environment that collectively provide the functionality of the integrating engine 240 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the integrating engine 240, as an Internet-based service, or as a module inside a search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or client computing devices. By way of example only, the integrating engine 240 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which searches may be integrated to include web page results, entity information, a combination thereof, or the like by discerning intent of a user and utilizing a web index, an entity index, or a combination thereof. As will be described in further detail below, embodiments of the present invention provide for integrating searches with varying types of information. Additional embodiments provide for compiling an entity index, processing a query using the entity index, and organizing the varying types of information for presentation.

The web index 220 may be configured to store one or more web pages. The one or more web pages, as will be discussed in detail below, may or may not be associated with an entity. An entity, as used herein, refers generally to anything that may be related to other information. For example, entities may be linked to a physical world (e.g., an entity may be a person, a place, a product, a company, a location, a combination thereof, or the like) or may be linked to a non-physical world (e.g., a virtual object such as a virtual game). Further, entities do not have to be “things” at all. Rather, entities may be concepts (e.g., a grand slam), time periods (e.g., the Victorian era), events (e.g., World War II), or the like.

The entity index 230 may be configured to store one or more entity files. An entity file, as used herein, refers generally to various data associated with a particular entity. The entity files may be in the form of a document, a spreadsheet, a table, a data structure, or any other known method for storing information. The entity index 230 may be created by the integrating engine 240, as discussed in detail below. Alternatively, the entity index 230 and the integrating engine 240 may be a single component of the computing system 200.

Both the entity index 230 and the web index 220 may be utilized to integrate searches. By way of example only, search queries may be sent to the entity index 230 to identify entities and use them as results. Alternatively, search queries may be sent to the web index 220 to look up web pages and use them as results or to identify entities associated with the returned web pages to use the associated entities as results either in place of or in addition to the web pages, or a combination thereof. Further, web pages and entities may be separately identified in each of the web index 220 and the entity index 230 and the results may be combined thereafter.

The integrating engine 240 may be configured to build the entity index 230, associate entities with information, and organize the information for presentation, among other things. The integrating engine 240 may be configured to ensure that the computing system 200 utilizes a common ontology, or language. Thus, as will be described in detail below, information received to compile or create the entity index 230 may be received from a variety of sources and, as a result, may require conversion to the common ontology. Additionally, the entity index 230 and the web index 220 may use a different ontology. In this situation, the information in the web index may be represented by the common ontology without the web index itself using the common ontology. Accordingly, the integrating engine 240 is configured to maintain consistency within the computing system 200.

With continued reference to FIG. 2, the integrating engine 240 includes a creating component 241, a referencing component 242, an identifying component 243, an associating component 244, a ranking component 245, and a presenting component 246. Each of the components is configured to enable the integrating engine 240 to build the entity index 230, associate entities with information, and organize the information for presentation. Additional components not illustrated in FIG. 2 may also be present.

The creating component 241 may be configured to create the entity index 230. Creating an entity index may include creating a plurality of entity files for each entity identified. Initially, creating an entity index starts with receiving data from various sources. The data may be received from crawling the Web, web feeds, commercial companies submitting data, or the like. For instance, an entity may be Restaurant X and data received may include a location of Restaurant X from an online mapping service, customer reviews from an online rating service, a phone number of Restaurant X from a telephone listing service, and the like. As is apparent, the information may come from a variety of sources but be related to the same entity.

The information received is analyzed by the creating component 241 to identify entity descriptions within the received information. Entity descriptions include the previously described information such as the name of the entity and other related information (e.g., a location, a phone number, a web site, etc.). Put simply, an entity description may be any terms used to identify an entity.

The creating component 241 may be further configured to, as previously mentioned, map each item of received information to a common ontology. Using the same ontology for each component of the computing system 200 ensures interoperability. As will be apparent, the common ontology allows for various information items to be associated with an entity, regardless of the source of the information or why the information was added to the entity index 230. As previously described, information may be received from various sources and, as such, there is a low likelihood that each source utilizes the same ontology. The creating component 241 may be configured to map each item of information to the common ontology.

In embodiments, a common ontology allows an entity to be described as a collection of properties and values. Relationships between entities are created by setting the value of one entity's property to be another entity. For example, the entity “Ron Howard” may be the “director of” the film entity “Apollo 13.” Using this ontology, all entities may be described using a set of properties and values. In the present example, a search for “Ron Howard” and a search for “the director of Apollo 13” would be associated with the same entity since the ontology describes each entity by a set of properties and values. Hence, the same entity information would be identified as related to the entity.

The creating component 241 may also be configured to merge entity files dealing with the same entity. For instance, a plethora of information may be received at different times for an entity, such as Movie A (e.g., viewer ratings, movie run time, actors, release date, title, synopsis, director, producer, etc.). However, the information is describing the same entity and duplicative entity files is not desirable as it is not efficient to locate information and is not an efficient use of space in the entity index 230. As such, the creating component 241 may merge the information together into a single entity file so there is only one entity file per each entity. Thus, an entity file for Movie A would include all of the different information received about Movie A (e.g., viewer ratings, movie run time, actors, release date, title, synopsis, director, producer, etc.) rather than creating a separate file for each of the items.

Items of information are merged together if they are similar enough. The first step in this comparison is to gather all properties two or more items have in common and compare corresponding property values. Different properties and values are compared using different algorithms such as Levenshtein distance for basic strings, Euclidean distance for geocodes, inclusion for dates, and specialized comparators for common types like names and addresses. The similarity scores for all properties are then combined using a model that weights properties by saliency for the type of entity being compared.

To increase the efficiency of merger, a number of techniques are used to limit the set of items that need to be compared. First, it is assumed that items of the same entity will share a common type, so only items with the same type need to be compared. Second, a blocking strategy may be defined for each type. A blocking strategy divides the pool of comparable items into subsets, or blocks, such that all items of the same entity fall into the same block and entities only need to be compared within a block.

Once the merger is complete and a single entity file is created for each entity, the entity and/or entity file may be assigned an entity identifier. The entity identifier may be a numeral or any other means of identifying different entities and/or entity files. The entity identifier will make it easier to reference a particular entity within the entity index 230 and will be described in further detail below.

The creating component 241 may also be configured to update the entity index 230 as new information is received. Thus, the creating component 241 does not have to re-create a new index each time updated entity information is received. Rather, the creating component 241 may update the entity files in order to keep the entity index 230 up-to-date.

Once an entity index has been created, the web index 220 may be referenced to integrate web index data with entity index data. The integration may be into a unified index. The unified index may be a separate index from the entity index 230 and the web index 220, a web index that includes entity index data, an entity index that includes web index data, a combination thereof, or the like. For instance, many web pages, such as restaurant pages, product reviews, news articles, and the like, may describe the same entity. Each provides different information about that entity and may be merged together into one unified description of the entity and linked to the unified index.

The referencing component 242 may be configured to reference the web index 220, the entity index 230, or a combination thereof, in order to integrate web index data and entity index data, as previously described. The referencing component 242 may also be configured to reference each of the web index 220 to identify any web index data that may be related to entity index data or to a web query, the entity index 230 to identify any entity index data that may be related to web index data or an entity query, or a combination thereof. The identifying step may be completed by the identifying component 243 of the integrating engine 240.

By way of example only, the web index 220 may include one or more web pages that describe Restaurant X. Restaurant X may be an entity that has been previously identified in the entity index 230. Thus, the entity index 230 may include an entity file for Restaurant X that has been associated with an entity identifier and includes one or more items of information for Restaurant X such as, but not limited to, a location, a telephone number, customer reviews, menus, types of cuisine, a reservation assistant, photos, videos, events, prices, hours of operation, and the like. When an entity is identified in the entity index 230, any web pages that are determined to be related to the entity from, for example, the web index 220, may be associated with the same entity identifier by the associating component 244. As a result, whenever the entity identifier is utilized, not only will the entity file from the entity index 230 be identified but any web page associated with the entity identifier will also be identified.

In order to determine whether a web page is related to an entity, several methods may be utilized. Initially, simply identifying keywords that are associated with an entity may be used. For instance, if the identified entity is “grand slam,” then any keywords related to a grand slam may be deemed to be associated with the entity based on previous user activity, click rates, and the like.

Additionally, some entity information that is received may already be associated with information identifying potentially related web pages. For instance, some information may already be associated with a web address. In this situation, the computing system 200 recognizes that a certain page was retrieved in order to view the content so the computing system 200 is aware of what page the content came from. Further, the web page may include additional links within the web page and these links may also be deemed to be related to the entity, depending on user preferences.

A web page similarity measurement may also be utilized to identify related web pages. In an embodiment, the web page similarity measurement is utilized when the entity is a person. This measurement is relevant when a person, for example, has a web page and an identifier is attached to each person's web page. The web pages may include similar content (e.g., overlap of keywords). This may result in a determination that a web page should be associated with an entity.

The associating component 244, as briefly mentioned, is configured to associate entity identifiers with any information associated with the entity. Thus, the associating component 244 may associate entity identifiers with information in the entity index 230 (e.g., entity files), information in the web index 220 (e.g., web pages), and the like.

The ranking component 245 may be configured to rank the entity information, the web pages, a combination thereof, or the like. The ranking component 245 may rank information prior to presentation of the information to a user. A search query may be sent to the entity index 230, the web index 220, or a combination thereof. When the search query is sent to the entity index 230, the ranking component 245 is configured to help select results from the entity index 230. When the search query is sent to the web index 220, the ranking component 245 is configured to help select results from the web index 220. When the search query is sent to both the web index 220 and the entity index 230, the ranking component 245 is able to access information that would otherwise only be available to a ranker associated with one of the indexes. The ranking component 245, in this case, is configured to use features of the web pages associated with the entities (because the entities have been linked to web pages) and use features of the entities associated with the web pages (because the web pages have been linked to the entities).

Information may be ranked in a variety of ways. Traditionally, keywords from a search query may be matched with web data. The search query would then yield a set of documents with corresponding keywords based on a title, URL, body of the document, links, other pages pointing to a particular page, clicks, anchors, or the like.

In the present model, an entity is not treated as a keyword. By treating the entity as structured data, the ranking component 245 is able to rank the data more precisely than the traditional “keyword-match” method. In this regard, the ranking component 245 discerns intent of a search query rather than simply identifying terms within a search query. For instance, if a search query is “Mexican restaurants open late in Bellevue,” the ranking component 245 immediately recognizes that not only is a Mexican restaurant desired but a Mexican restaurant in a particular location with late hours of operation is desired. Thus, the ranking component 245 may rank information including a Mexican restaurant with extended hours of operation and a location higher than a result that simply returns a Mexican restaurant or a result that returns a Mexican restaurant that closes at 8 p.m. Another simple example would be identifying the query “George Washington's wife” as intent to search for “Martha Washington” rather than items including the terms “George Washington's wife.” The ranking component 245 may then be able to identify items associated with the same entity identifier as “Martha Washington” and rank those items higher than items that simply include the same terms as the search query.

By way of further example, assume a search query is “best restaurant.” A simple keyword search of this query would not be beneficial as it would likely yield web pages for restaurants that actually use the word “best” within the content. The ranking component 245, however, is configured to identify that the intent of the search query is to find restaurants with the best customer reviews. Thus, the ranking component 245 may rank restaurants with five-star ratings higher in the SERP than restaurants with two-star ratings.

One of the central assumptions in integrating searches is that entity results share the same standing as web results. Some user queries are best answered with a stream of web page results, others are best answered by a stream of entity results, and many by a mixture of the two. Thus, entities should be retrieved for all user queries so the ranking component 245 is able to select the appropriate mix of entity and web results.

The presenting component 246 is configured to present the information to the user. The presenting component 246 may present the information in the order determined by the ranking component 245. The presenting component 246 may present web pages, entity information, or a combination thereof from the web index 220, the entity index 230, or a combination thereof. The way information is presented may depend on the search query itself. For instance, a search query may be a query for a single entity, a category of entities, or the like. Additionally, multimedia content may be integrated into the SERP.

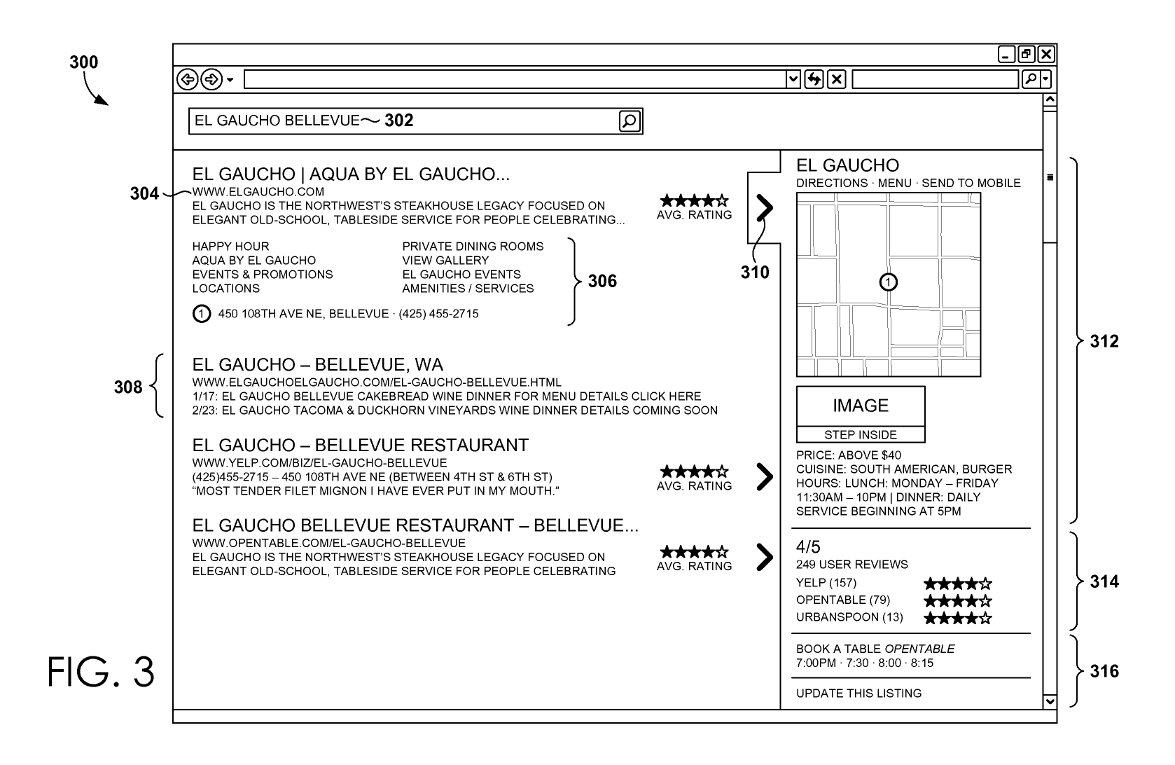

A search query for a single entity may yield an exemplary user interface 300 provided in FIG. 3. As illustrated, a search query 302 is indicated in a search query input area and is for a particular restaurant (i.e., El Gaucho) in a particular location (i.e., Bellevue). In the user interface 300 the first result provided is the richest result as it includes both a web page 304 (i.e., web index data) and entity data 306. As indicated, the second result 308 provides a web page and some entity data.

The entity data that is provided may be entity data that is extracted directly from the web page (from the web index 220, for example), aggregated entity data (from the entity index 230, for example) about the identified entity, or the like. If entity data is presented and is not from the web page, the entity data may be explicitly marked such that a user is aware that the data is not from the web page and is not inadvertently led to click the web page result thinking that the entity data will be present. The entity data may be periodically updated to ensure up-to-date results.

User interface 300 also provides an expand indicator 310 that expands into an expanded view for the search result corresponding to the selected indicator. In this instance, the expand indicator 310 corresponds to the first search result so the expanded view includes entity information for the first result. As provided, the expanded view includes a general entity information area 312 that provides a map, price, cuisine type, hours of operation, and the like. The general entity information area 312 may be configured to display any desired information. The expanded view also includes a review area 314 and a reservation assistant 316.

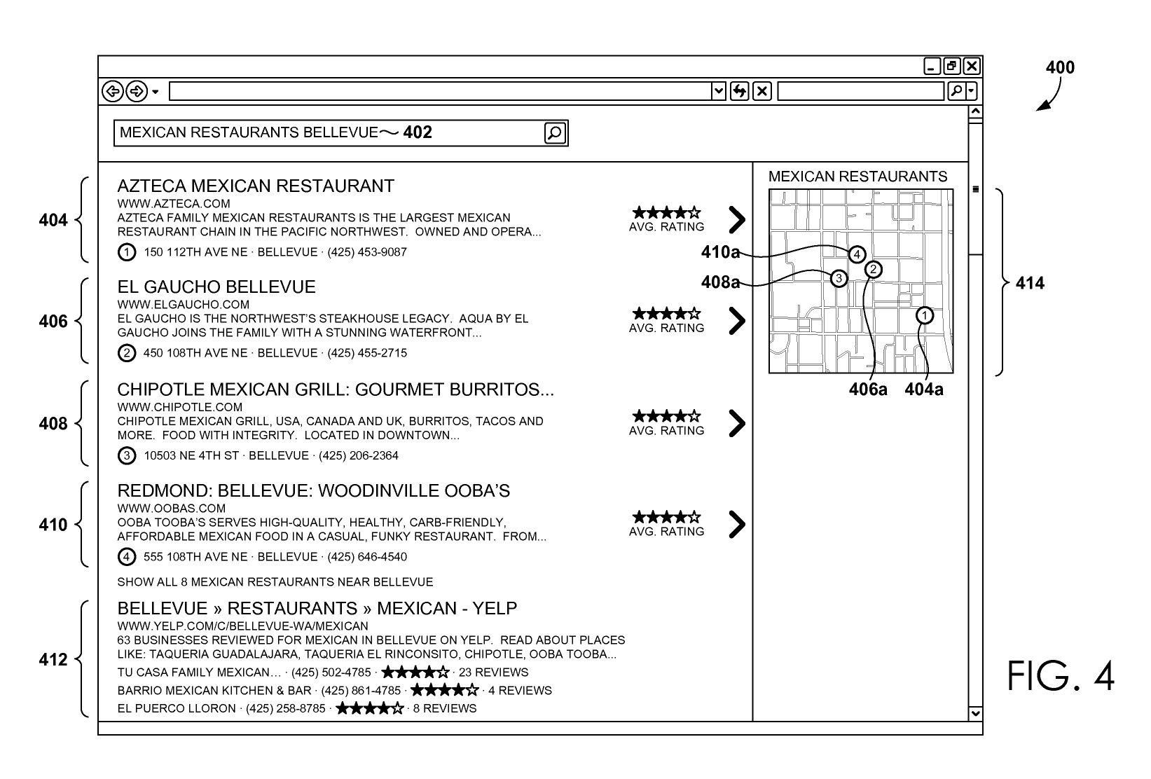

Alternatively, a search query may indicate a category of entities, as provided by the exemplary user interface 400 of FIG. 4. In this example, a search query 402 has been entered into a search query input area and indicates a category of entities to search (i.e., Mexican restaurants in Bellevue). By way of further example, entity category searches may be category searches by name (e.g., James Bond movies), category searches by constraints (e.g., movies directed by Steven Spielberg and starring Tom Hanks), or the like. As previously described, the common ontology enables the system to identify a user's intent from the search query and identify related entity information.

Several results are returned and are indicated as results 404, 406, 408, 410, and 412. As indicated in each of results 404, 406, 408, 410, and 412, a combination of web page information and entity information may be included in the result display. Additionally, a general entity information area 414 is included. As illustrated in FIG. 4, unless a user selects an expand indicator, the general entity information area 414 will display general information for each of the search results 404, 406, 408, 410, and 412. For instance, in FIG. 4 a user has not yet selected any expand indicators so the general entity information area 414 includes a map indicating locations 404a, 406a, 408a, and 410a that correspond to results 404, 406, 408, and 410.

Additionally, user interfaces may be presented by the presenting component 246 such that multimedia content may be integrated into the SERP including entity information. For instance, the information of either user interface 300 or user interface 400 may be presented but in addition to multimedia content such as photos, videos, sound clips, or the like. The multimedia content may be included in the SERP among the results such that they are immediately available to a user without the user needing to click on a multimedia indicator, as is traditionally done. In this case, users do not need to click on a “photos” link or a “videos” link as the multimedia content is integrated directly into the SERP.

In embodiments, users can preview multimedia content, without actually selecting it, by hovering over the content. For instance, a user may hover over a video icon to view a summary video without having to actually select the video and be navigated to a different page. This way, the user is able to quickly determine if they wish to continue on and select the video or if they would prefer to look at another result.

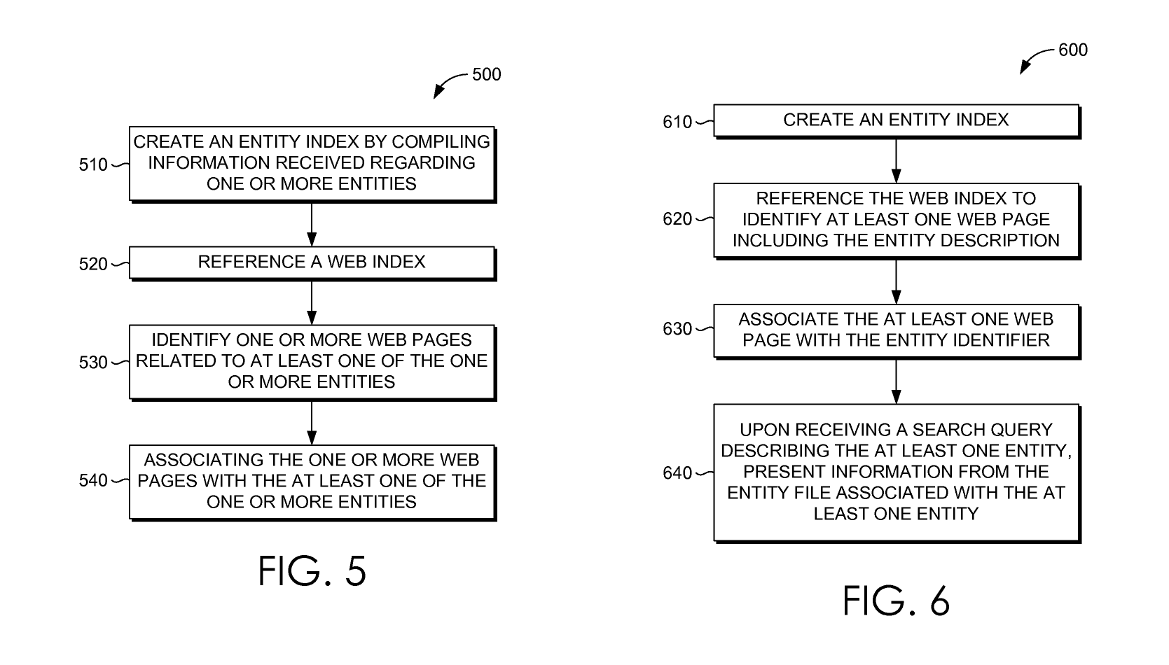

Referring now to FIG. 5, a flow diagram is provided that illustrates an overall method 500 for integrating searches, in accordance with an embodiment of the present invention. Initially, as shown at block 510, an entity index is created by compiling information received regarding one or more entities. At block 520, a web index is referenced. One or more web pages, from the web index, is identified as related to at least one of the one or more entities at block 530. The one or more web pages identified as related to the at least one of the one or more entities is associated with the at least one of the one or more entities at block 540.

Referring now to FIG. 6, a flow diagram is provided that illustrates an overall method 600 for integrating searches, in accordance with an embodiment of the present invention. Initially, as shown at block 610, an entity index is created that includes entity information for a plurality of entities. At block 620, a web index is referenced to identify at least one page including the entity description. Web pages including an entity description are determined to be related to the entity. At block 630, the at least one web page is associated with an entity identifier that is associated with the entity. At block 640, upon receiving a search query describing one or more entities, information from one or more entity files associated with the one or more entities identified within the search query is presented.

As can be understood, embodiments of the present invention provide systems, methods, and computer storage media having computer-usable instructions embodied thereon, for integrating searches.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method, the method comprising:
creating an entity index by compiling information received regarding one or more entities;
referencing a web index, wherein the web index includes a plurality of web pages;
identifying one or more web pages related to at least one of the one or more entities; and
associating the one or more web pages with the at least one of the one or more entities.

2. The one or more computer storage media of claim 1, wherein an entity is a physical thing existing in a physical world.

3. The one or more computer storage media of claim 1, wherein an entity is a concept or a non-physical thing existing in a virtual world.

4. The one or more computer storage media of claim 1, wherein the one or more web pages is associated with at least one of the one or more entities by associating each of the one or more web pages and the at least one of the one or more entities with an entity identifier that is the same.

5. The one or more computer storage media of claim 4, further comprising:
receiving a search query including an entity;
identifying an entity identifier associated with the entity; and
identifying, with the web index, a plurality of web pages including one or more web pages associated with the entity identifier of the plurality of web pages.

6. The one or more computer storage media of claim 5, further comprising:
receiving a search query including an entity;
identifying an entity identifier associated with the entity; and
identifying entity information associated with the entity identifier from the entity index.

7. The one or more computer storage media of claim 6, further comprising presenting the entity information associated with the entity identifier in combination with a plurality of web pages associated with the entity identifier.

8. The one or more computer storage media of claim 1, wherein the entity index is created by identifying entity descriptions within the information received and mapping the entity descriptions to at least one entity.

9. A system for integrating searches, comprising:
a computing device associated with one or more processors and one or more computer-readable storage media;
a data store coupled with the computing device; and
an integrating engine that
creates an entity index by compiling information received regarding one or more entities;
references a web index, wherein the web index includes a plurality of web pages;
identifies one or more web pages related to at least one of the one or more entities; and
associates the one or more web pages with the at least one of the one or more entities.

10. The system of claim 9, wherein an entity is a physical thing existing in a physical world.

11. The system of claim 9, wherein an entity is a concept or a non-physical thing existing in a virtual world.

12. The system of claim 9, wherein the one or more web pages is associated with at least one of the one or more entities by associating each of the one or more web pages and the at least one of the one or more entities with an entity identifier that is the same.

13. The system of claim 9, wherein the integrating engine is further configured to, upon receiving a search query, identify one or more entities described within the search query and present a web page associated with at least one of the one or more entities based on an entity identifier associated with the one or more entities and the web page.

14. The system of claim 9, wherein the integrating engine is further configured to merge duplicate entity identifiers with one another such that a single entity file exists for each entity identifier.

15. One or more computer storage media storing computer-useable instructions that, when used by one or more computing devices, cause the one or more computing devices to perform a method, the method comprising:
creating an entity index by
(a) compiling information received regarding one or more entities;
(b) analyzing the information received regarding the one or more entities to identify an entity description for at least one entity described within the information received;
(c) mapping the information received regarding the one or more entities to a common ontology;
(d) merging each item of information including the entity description for the at least one entity into an entity file; and
(e) assigning an entity identifier to the entity file for the at least one entity;
referencing the web index to identify at least one web page including the entity description for the at least one entity;
associating the at least one web page with the entity identifier; and
upon receiving a search query describing the at least one entity, presenting information from the entity file associated with the at least one entity identified within the search query.

16. The one or more computer storage media of claim 15, further comprising presenting the information from the one or more entity files associated with the one or more entities described within the search query in conjunction with a plurality of web pages associated with an entity identifier that is also associated with the one or more entity files.

17. The one or more computer storage media of claim 16, further comprising ranking the one or more entity files associated with the one or more entities described within the search query.

18. The one or more computer storage media of claim 16, further comprising ranking the plurality of web pages associated with the entity identifier that is also associated with the one or more entity files.

19. The one or more computer storage media of claim 15, further comprising ranking both the one or more entity files and the plurality of web pages from both the entity index and the web index.

20. The one or more computer storage media of claim 15, wherein determining that the information received is related to one or more entities includes one or more of identifying a web page address from which the information was obtained and identifying a similarity measurement between the one or more entities and a particular web page.
